(19) United States
(12) Patent Application Publication
(10) Pub. No.: US 2016/0140068 A1
(43) Pub. Date: May 19, 2016

(54) ELECTRONIC DEVICE ASSEMBLY

(71) Applicant: HON HAI PRECISION INDUSTRY CO., LTD., New Taipei (TW)

(72) Inventor: CHING-CHUNG LIN, New Taipei (TW)

(21) Appl. No.: 14/587,256

(22) Filed: Dec. 31, 2014

(30) Foreign Application Priority Data
Nov. 14, 2014 (CN) 201410644571.9

(51) Int. Cl. G06F 13/40; G06F 13/42; H04N 5/655; G06F 13/364

(52) U.S. Cl. CPC G06F 13/4022; G06F 13/364; G06F 13/4282; H04N 5/655

(57) ABSTRACT

An electronic device connecting system includes a master electronic device and a plurality of slave electronic devices. The master electronic device includes a connecting module and a MCU. Each slave electronic device includes a coupling module. The connecting module includes a plurality of port assemblies. Each port assembly is configured to couple a function device and includes a plurality of connecting ports and a switch assembly. The coupling module includes a plurality of coupling ports. When the master electronic device is coupled to one of the slave electronic devices, the MCU controls the switch assemblies to switch on the corresponded connecting ports and coupling ports, enabling the function devices to be synchronously connected to the one of the slave electronic devices and the master electronic device.

### FIELD

The subject matter herein generally relates to electronic device assemblies.

### BACKGROUND

Electronic devices, such as electronic white boards, are always coupled to a plurality of slave devices, such as mobile phones, universal serial buses (USBs), and so on. The plurality of slave devices is connected to the main electronic devices in parallel.

### BRIEF DESCRIPTION OF THE DRAWINGS

Implementations of the present technology will now be described, by way of example only, with reference to the attached figures.

FIG. 1 is a block diagram of one embodiment of an electronic device assembly.

FIG. 2 is a block diagram of a master device of the electronic device assembly of FIG. 1.

FIG. 3 is a block diagram of a slave device of the electronic device assembly of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

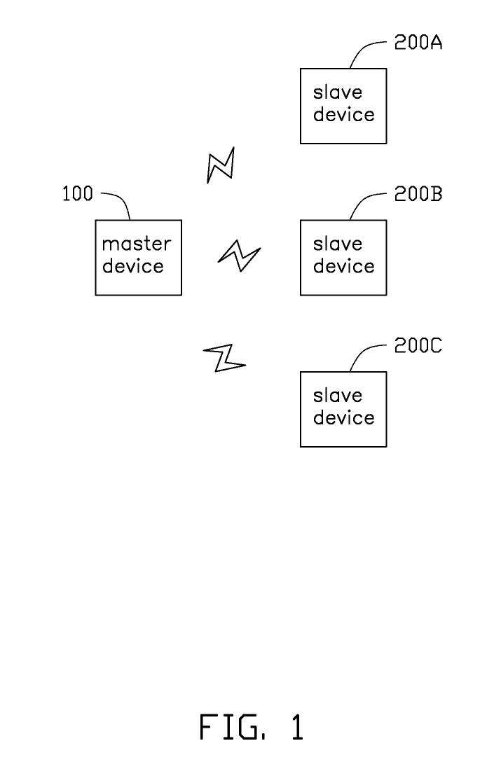

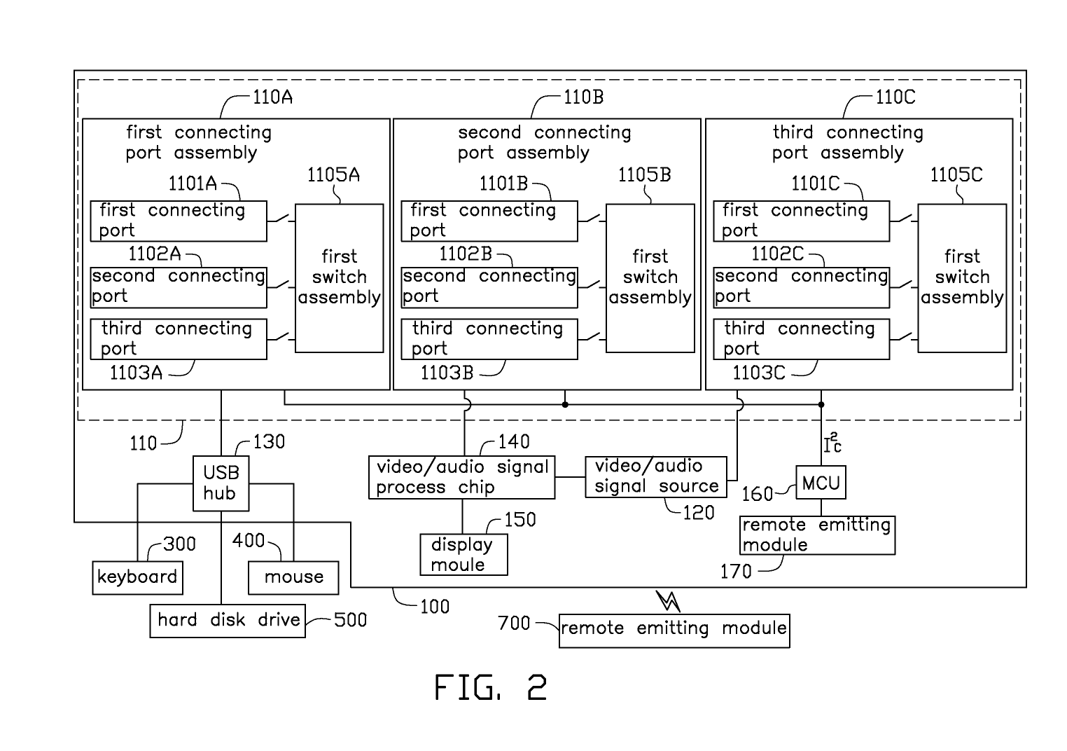

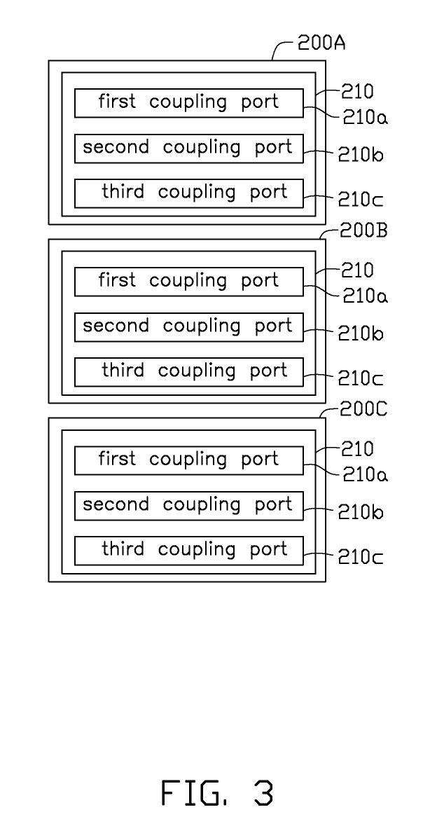

FIGS. 1-3 illustrate an electronic device assembly in accordance with an embodiment. The electronic device assembly can include a master device 100 and a plurality of slave devices 200A-200C. In at least one embodiment, the master device 100 can be a monitor, a television (TV) or a mobile phone, and the plurality of slave devices 200A-200C can be tablet computers, mobile phones, power supplies, hard disks, routers and so on. The master device 100 can be coupled to the slave devices 200A-200C via a wireless method, such as BLUETOOTH, WiFi, and WiGig, or cables.

The master device 100 can include a connecting module 110, and the connecting module 110 can include a plurality of connecting port assemblies. Each connecting port assembly is coupled to a function device, such as a USB hard disk drive, a BLUETOOTH keyboard, a mouse, and a wireless video device, to achieve a specific function. The number of the connecting port assemblies is no less than the number of the types of the specific functions. Each connecting port assembly can include a plurality of connecting ports. Each connecting port is configured to couple to a coupling port of one of the slave devices 200A-200C, enabling the corresponded function device to couple to the one of the slave devices 200A-200C. The number of the connecting ports is no less than the number of the slave devices.

In at least one embodiment, the plurality of connecting port assemblies can include a first connecting port assembly 110A, a second connecting port assembly 110B, and a third connecting port assembly 110C. The first connecting port assembly 110A can include a first connecting port 1101A, a second connecting port 1102A, a third connecting port 1103A, and a first switch assembly 1105A. The second connecting port assembly 110B can include a first connecting port 1101B, a second connecting port 1102B, a third connecting port 1103B, and a second switch assembly 1105B. The third connecting port assembly 110C can include a first connecting port 1101C, a second connecting port 1102C, a third connecting port 1103C, and a third switch assembly 1105C. In at least one embodiment, the connecting module 110 can be a radio frequency module or cables. In at least one embodiment, the type of the first connecting port assembly 110A, the second connecting port assembly 110B, and the third connecting port assembly 110C may be HDMI, MHL, USB, DP, and E SATA.

Each slave device 200A, 200B, 200C can include a coupling module 210, and the coupling module 210 can include a first coupling port 210a, a second coupling port 210b, and a third coupling port 210c. The first coupling ports 210a are coupled to the first connecting port 1101A, the second connecting port 1102A, and the third connecting port 1103A respectively. The second coupling ports 210b are coupled to the first connecting port 1101B, the second connecting port 1102B, and the third connecting port 1103B respectively. The third coupling ports 210c are coupled to the first connecting port 1101C, the second connecting port 1102C, and the third connecting port 1103C respectively.

The type of the first coupling port 210a is different from the second coupling port 210b and the third coupling port 210c, and the second coupling port 210b is different from the third coupling port 210c. The type of each first coupling port 210a is same as the type of the first connecting port 1101A, the second connecting port 1102A, and the third connecting port 1103A.

The type of each second coupling port 210b is same as the type of the first connecting port 1101B, the second connecting port 1102B, and the third connecting port 1103B. The type of each third coupling port 210c is same as the type of the first connecting port 1101C, the second connecting port 1102C, and the third connecting port 1103C. In at least one embodiment, the type of the first coupling port 210a, the second coupling port 210b and the third coupling port 210c may be wireless fidelity (WiFi) or BLUETOOTH (BT) or WiGig.

The master device 100 can further include a video/audio signal source 120, a universal serial bus (USB) hub 130, a video/audio signal process chip 140, a display module 150, and a micro controller unit (MCU) 160, and a remote signal receiving module 170.

The video/audio signal source 120 is coupled to the third connecting port assembly 110C and the MCU 140 and can capture an image/voice and send the image/voice to the slave devices 200A-200C through the third connecting port assembly 110C. The image/voice can from a camera or the MCU 140. The master device 100 and the slave devices 200 can both display the image/voice.

The USB hub 130 is coupled to a keyboard 300, a mouse 400, and a hard disk drive 500. The keyboard 300 and the mouse 400 are taken as an input device and can control the master device 100 and each of the slave devices 200A-200C coupled to the master device 100 at the same time. In other embodiments, the input device can be a touch pad. The hard disk drive 500 is taken as a storage device of each of the slave devices 200A-200C when each of the slave devices 200A-200C is coupled to the master device 100.

The video/audio signal process chip 140 is coupled to the second connecting port assembly 110B and the display module 150 and configured to output video signals from the first connecting port 1101B, the second connecting port 1102B, and the third connecting port 1103B to the display module 150. The video/audio signal process chip 140 is further configured to output audio signals to an audio receiving device with a wireless sound power amplifier (not shown).

The MCU 160 is coupled to the first connecting port assembly 110A, the second connecting port assembly 110B, and the third connecting port assembly 110C via an I2C bus and C BUS. The MCU 160 is capable of controlling the first switch assembly 1105A, the second switch assembly 1105B, and the third switch assembly 1105C to switch on or off corresponding connecting ports and coupling ports.

The remote receiving module 170 is coupled to the MCU 160. The electronic device assembly can further include a remote emitting module 700, such as remote control or a BT module of a mobile phone. The remote emitting module 700 has a plurality of buttons (not shown) corresponding to the slave devices 200A-200C. When a button is pressed, the remote receiving module 170 receives a command to drive the MCU 160 to control the first switch assembly 1105A, the second switch assembly 1105B, and the third switch assembly 1105C to switch on or off corresponding connecting ports and coupling ports.

When the slave device 200A is coupled to the master device 100, the MCU 160 switches on the first connecting port 1101A, the second connecting port 1101B, and the third connecting port 1101C, the keyboard 300, the mouse 400, the hard disk drive 500, the video/audio signal source 120, and the display module 150 are synchronously coupled to the slave device 200A and the master device 100. When the slave device 200B is coupled to the master device 100, the MCU 160 switches on the first connecting port 1102A, the second connecting port 1102B, and the third connecting port 1102C, the keyboard 300, the mouse 400, the hard disk drive 500, the video/audio signal source 120, and the display module 150 are synchronously coupled to the slave device 200B and the master device 100. When the slave device 200C is coupled to the master device 100, the MCU 160 switches on the first connecting port 1103A, the second connecting port 1103B, and the third connecting port 1103C, the keyboard 300, the mouse 400, the hard disk drive 500, the video/audio signal source 120, and the display module 150 are synchronously coupled to the slave device 200C and the master device 100. In at least one embodiment, the video/audio signal source 120 is a camera, a DVD, computer, and a set top box.

In at least one embodiment, the master device 100 is a monitor, the slave device can be a host, a set top box, a mobile phone, a telephone, a TV, a network, and a router. When the monitor is coupled to the host, the electronic device assembly is a computer; when the monitor is coupled to the set top box, the electronic device assembly is a TV.

The embodiments shown and described above are only examples. Many details are often found in the art such as the other features of an electronic device assembly. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims. It will therefore be appreciated that the embodiments described above may be modified within the scope of the claims.

What is claimed is:

1. An electronic device assembly comprising:
a master device comprising a micro control unit (MCU) and a connecting module, the connecting module comprising a plurality of connecting port assemblies, each connecting port assembly configured to couple to a function device and comprising a plurality of connecting ports and a switch assembly; and
a plurality of slave devices, each slave device comprising a coupling module, and the coupling module comprising a plurality of coupling ports;
wherein each coupling module is configured to couple to each connecting port assembly, and the plurality of coupling ports of each coupling module is configured to couple to one of each connecting port of the connecting port assemblies respectively; and
when the master device is coupled to one of the slave devices, the MCU controls the switch assemblies to couple to the coupling ports of the one of the slave devices and the corresponded connecting ports, and enable the function devices to be synchronously coupled to the one of the slave devices and the master device.

2. The electronic device assembly of claim 1, wherein the type of each connecting port is same as each other in each connecting port assembly and is different from the connecting ports in each other connecting port assemblies.

3. The electronic device assembly of claim 2, wherein the connecting port assemblies comprises a HDMI connecting port assembly, a MHL connecting port assembly, a USB connecting port assembly, or C BUS connecting port assembly.

4. The electronic device assembly of claim 2, wherein a number of the connecting ports of each connecting port assembly is no less than a number of the slave devices.

5. The electronic device assembly of claim 2, wherein a number of the connecting port assembly is no less than the function devices.

6. The electronic device assembly of claim 1, wherein the master device further comprises a universal serial bus (USB) hub configured to couple to a first connecting port assembly, an input device and a storage device are configured to couple to the USB hub.

7. The electronic device assembly of claim 1, wherein the master device further comprises a video/audio signal source coupled to a third connecting port assembly, and the video/audio signal source is configured to send video/audio signal to the slave devices.

8. The electronic device assembly of claim 7, wherein the master device further comprises a video/audio signal process chip coupled to a second connecting port assembly, and the video/audio signal process chip is configured to send video/audio signal from the slave devices to the master device.

9. The electronic device assembly of claim 8, wherein the master device further comprises a display module coupled to the video/audio signal process chip and configured to display videos of the video signal from the video/audio signal process chip.

10. The electronic device assembly of claim 1, further comprising a remote emitting module having a plurality of buttons corresponding to the slave devices, wherein the master device further comprises a remote receiving module coupled to the MCU, when one of the buttons is pressed, the remote receiving module drives the MCU to control the switches assemblies to couple the coupling ports of one of the slave device corresponding to the one of the buttons to the corresponding connecting ports.

11. An electronic device assembly comprising:
a master device comprising:
a micro control unit (MCU);
a remote receiving module coupled to the MCU; and
a connecting module comprising a plurality of connecting port assemblies, each connecting port assembly configured to couple to a function device and comprising a plurality of connecting ports and a switch assembly;
a plurality of slave devices, each slave device comprising a coupling module, and the coupling module comprising a plurality of coupling ports; and
a remote emitting module having a plurality of buttons corresponding to the slave devices
wherein each coupling module is configured to couple to each connecting port assembly, and the plurality of coupling ports of each coupling module is configured to couple to one of each connecting port of the connecting port assemblies respectively; and
when one of the buttons is pressed, the master device is coupled to one of the slave devices corresponding to the one of the buttons, the remote receiving module drives the MCU to control the switch assemblies to couple the coupling ports of the one of the slave devices and the corresponded connecting ports, enable the function devices to be synchronously coupled to the one of the slave devices and the master device.

12. The electronic device assembly of claim 11, wherein the type of each connecting port is same as each other in each connecting port assembly and is different from the connecting ports in each other connecting port assemblies.

13. The electronic device assembly of claim 12, wherein the connecting port assemblies comprises a HDMI connecting port assembly, a MHL connecting port assembly, a USB connecting port assembly, or C BUS connecting port assembly.

14. The electronic device assembly of claim 12, wherein a number of the connecting ports of each connecting port assembly is no less than a number of the slave devices.

15. The electronic device assembly of claim 12, wherein a number of the connecting port assembly is no less than the function devices.

16. The electronic device assembly of claim 11, wherein the master device further comprises a universal serial bus (USB) hub configured to couple to a first connecting port assembly, an input device and a storage device are configured to couple to the USB hub.

17. The electronic device assembly of claim 11, wherein the master device further comprises a video/audio signal source coupled to a third connecting port assembly, and the video/audio signal source is configured to send video signal to the slave devices.

18. The electronic device assembly of claim 17, wherein the master device further comprises a video/audio signal process chip coupled to a second connecting port assembly, and the video/audio signal process chip is configured to send video signal from the slave devices to the master device.

19. The electronic device assembly of claim 18, wherein the master device further comprises a display module coupled to the video/audio signal process chip and configured to display videos of the video signal from the video/audio signal process chip.

20. The electronic device assembly of claim 11, wherein the connecting port assemblies are respectively wireless fidelity (WiFi), BLUETOOTH, and WiGig.
